(19) United States
(12) Patent Application Publication
(10) Pub. No.: US 2026/0193922 A1
(43) Pub. Date: Jul. 9, 2026

(54) VEHICLE DOOR CHECKER ASSEMBLY

(71) Applicants: Hyundai Motor Company, Seoul (KR); Kia Corporation, Seoul (KR); ILJIN Co., Ltd., Gyeongju-si (KR)

(72) Inventors: Gi Ho Kwon, Hwaseong-si (KR); Heung Tae Kim, Seoul (KR); Jun Yong Seo, Seoul (KR); Jeong Rae Lee, Seoul (KR); Jae Yong Lee, Seoul (KR)

(21) Appl. No.: 19/383,002

(22) Filed: Nov. 7, 2025

(30) Foreign Application Priority Data
Nov. 20, 2024 (KR) 10-2024-0166535

(51) Int. Cl. E05F 5/06; B60J 5/10

(52) U.S. Cl. CPC E05F 5/06; B60J 5/10

(57) ABSTRACT

Proposed is a vehicle door checker assembly mounted between a vehicle body and a door to assist in an opening and closing operation of the door, the assembly including a body mounting part mounted on the body, a door mounting part mounted on the door, a checker arm configured to penetrate the body mounting part and move relative to the body mounting part, and a locking latch that moves the checker arm between a latched position and a release position in cooperation with a coupling groove of the door mounting part, wherein a damper member is arranged in the coupling groove, and in the latched position, a portion of the checker arm is surrounded by the coupling groove, the locking latch and the damper member.

### CROSS-REFERENCE TO RELATED APPLICATIONS

The present application claims priority to Korean Patent Application No. 10-2024-0166535, filed November 20, 2024, the entire contents of which is incorporated herein for all purposes by this reference.

### TECHNICAL FIELD

The present disclosure relates to a vehicle door checker assembly and, more particularly, to a vehicle door checker assembly capable of reducing noise or vibration from a checker arm pin and a checker arm pin fastening groove by eliminating clearance between the checker arm pin and the checker arm pin fastening groove from the checker arm pin fastening groove formed in a door housing.

### BACKGROUND

A vehicle door checker assembly is installed and utilized in the vehicle's door to assist the door opening and closing maneuvers. For example, the door checker assembly may be installed between the vehicle's body and the door and configured to perform the function of limiting the maximum opening angle of the door and maintaining the door in an open state at a predetermined angle.

Among door checker assemblies, there are door checker assemblies that are configured not to allow the door to open beyond a predetermined maximum opening angle in normal times, but to allow the door to open beyond a predetermined maximum opening angle if desired by a user.

FIG. 1 shows an example of a conventional door checker assembly 1. As shown in FIG. 1, a checker arm 2 may be configured to be connected to a door mounting part 3 by a pin 4. When a user wants to open the door beyond a predetermined maximum opening angle, the user can manually separate the pin 4 from the door mounting part 3 and the checker arm 2 to further open the door.

However, the above structure causes considerable inconvenience or difficulty to the user because, when the user opens the door and then closes the door again, a pin hole of the door mounting part 3 and a pin hole of the checker arm 2 should be aligned and the pin 4 should be inserted into the aligned pin holes.

Moreover, when separating the pin 4 from the door mounting part 3 and the checker arm 2, considerable inconvenience is caused to the user due to interference stemming from dimensional deviation of the pin and pin holes.

As an example of a solution to the above-mentioned inconvenience, a prior art discloses a vehicle door checker assembly having a structure in which a groove is formed in a door mounting part and a checker arm is automatically fastened into the groove by a latch member.

However, in the vehicle door checker assembly, because of the clearance between the checker arm and the groove, noise or vibration occurs between the checker arm and the groove when the checker arm is introduced into the groove or when the checker arm is rotated while being engaged by the latch member within the groove.

The description provided above as a related art of the present disclosure is just for helping understand the background of the present disclosure and should not be construed as being included in the related art known by those skilled in the art.

### SUMMARY

An objective of the present disclosure is to provide a vehicle door checker assembly capable of reducing noise or vibration from a checker arm pin and a checker arm pin fastening groove by eliminating clearance between the checker arm pin and the checker arm pin fastening groove from the checker arm pin fastening groove formed in a door housing.

In order to achieve the objectives of the present disclosure, there is provided a vehicle door checker assembly mounted between a vehicle body 20 and a door 30 to assist in an opening and closing operation of the door 30, the assembly including: a body mounting part 200 configured to be mounted on the body 20; a door mounting part 100 configured to be mounted on the door 30; a checker arm 300 configured to penetrate the body mounting part 200 and move relative to the body mounting part 200; and a locking latch 400 configured to move the checker arm 300 between a latched position and a release position in cooperation with a coupling groove 115 of the door mounting part 100, wherein a damper member 500 is arranged in the coupling groove 115 of the door mounting part 100, and in the latched position, a portion of the checker arm 300 is surrounded by the coupling groove 115, the locking latch 400 and the damper member 500.

According to an embodiment of the present disclosure, the coupling groove 115 may include: a damper member coupling surface 131 on which the damper member 500 is installed; a first inner surface 133 extending from a first end of the damper member coupling surface 131; and a second inner surface 135 extending from a second end of the damper member coupling surface 131, wherein the portion of the checker arm 300 may be guided toward the damper member 500 along at least one of the first inner surface 133 and the second inner surface 135 so as to come into contact with the damper member 500.

According to an embodiment of the present disclosure, a cross-sectional shape formed by the damper member coupling surface 131 may partially correspond to a cross-sectional shape of the damper member 500.

According to an embodiment of the present disclosure, the first inner surface 133 may include: a first guide surface 136 configured to guide and move the portion of the checker arm 300; and a first connection surface 137 connecting the first guide surface 136 and the damper member coupling surface 131, wherein a cross-sectional shape formed by the first connection surface 137 may partially correspond to a cross-sectional shape of the portion of the checker arm 300.

According to an embodiment of the present disclosure, door mounting part 100 may include: a housing 110 in which the coupling groove 115 is formed; and a cover 600 configured to at least partially cover the damper member 500 so that the damper member 500 does not come out of the housing 110.

According to an embodiment of the present disclosure, the door mounting part 100 may include a shaft 450 for pivotally mounting the locking latch 400 to the housing 110, wherein a portion of the cover 600 may be interposed and fixed between the housing 110 and a fixing flange 452 of the shaft 450.

According to an embodiment of the present disclosure, the cover 600 may include: a shaft mounting part 620 provided with a through hole 610 through which the shaft 450 passes and having a shape at least partially corresponding to the fixing flange 452 of the shaft 450; and a damper member cover part 630 configured to at least partially cover the damper member 500.

According to an embodiment of the present disclosure, the cover 600 may further include a fitting joint part 640 that is coupled to the housing 110.

According to an embodiment of the present disclosure, the shaft mounting part 620 may be arranged between the damper member cover part 630 and the fitting joint part 640.

According to an embodiment of the present disclosure, the fitting joint part 640 may include a protrusion 640a protruding toward the housing 110, and a hole 121 or a concave groove that is coupled with the protrusion 640a may be formed in the housing 110.

According to an embodiment of the present disclosure, the damper member 500 may be made of rubber material.

According to an embodiment of the present disclosure, the checker arm 300 may include a pin 330 at a door-side end thereof, and the pin 330 may operate as the portion of the checker arm 300.

According to an embodiment of the present disclosure, by eliminating clearance between the checker arm pin and the checker arm pin fastening groove from the checker arm pin fastening groove formed in a door housing, noise and vibration from the checker arm pin and the checker arm pin fastening groove can be reduced.

According to an embodiment of the present disclosure, a damper member is covered by a damper member cover, so that the risk of the damper member being detached from a housing due to repeated impacts can be eliminated.

### BRIEF DESCRIPTION OF THE DRAWINGS

FIG. 1 shows an example of a conventional door checker assembly.

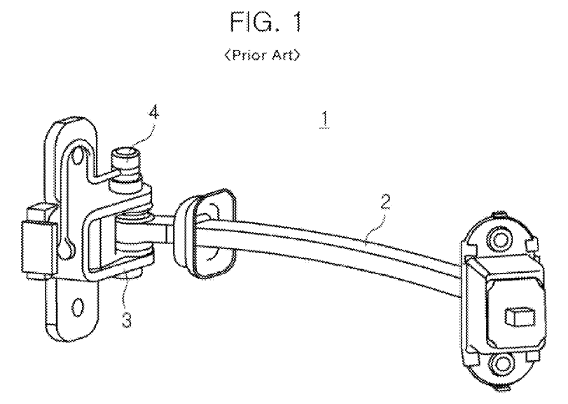

FIG. 2 is a view showing the opening and closing of a door of a vehicle having a vehicle door checker assembly installed according to an embodiment of the present disclosure.

FIG. 3 shows a vehicle door checker assembly with the door closed according to an embodiment of the present disclosure.

FIG. 4 shows a vehicle door checker assembly with the door opened to the maximum opening angle thereof according to an embodiment of the present disclosure.

FIG. 5 shows a vehicle door checker assembly with the door opened beyond the maximum opening angle thereof according to an embodiment of the present disclosure.

FIG. 6 shows a checker arm according to an embodiment of the present disclosure.

FIG. 7 is a view showing the coupling of a checker arm and a pin according to an embodiment of the present disclosure.

FIG. 8 is a partial perspective view of a vehicle door checker assembly according to an embodiment of the present disclosure.

FIG. 9 is an exploded perspective view of a housing and components coupled therein of a vehicle door checker assembly according to an embodiment of the present disclosure.

FIG. 10 shows a state in which a pin of a checker arm is coupled to a locking latch according to an embodiment of the present disclosure.

FIG. 11 shows a state in which a pin of a checker arm is detachable from a locking latch according to an embodiment of the present disclosure.

FIG. 12 is a perspective view of a cover according to an embodiment of the present disclosure.

### DETAILED DESCRIPTION OF ILLUSTRATIVE EMBODIMENTS

Hereafter, a preferred embodiment of the present disclosure will be described in detail with reference to the attached drawings.

In order to clearly explain the present disclosure, detailed descriptions of parts unrelated to the present disclosure are omitted, and the same reference numerals are used to describe the same components throughout the specification. In addition, since the shape and size of each component illustrated in the drawing are arbitrarily illustrated for convenience of explanation, the present disclosure is not necessarily limited to the illustrated shape and size. That is, it should be understood that specific shapes, structures, and characteristics described in the specification may be modified and implemented from one embodiment to another without departing from the spirit and scope of the present disclosure, and that the positions or arrangements of individual components may also be changed without departing from the spirit and scope of the present disclosure. Therefore, the detailed description set forth below is not intended to be limiting, and the scope of the present disclosure should be accepted as encompassing the scope claimed in the claims and all scopes equivalent thereto.

Expressions such as “comprise”, “provided with”, or “have” used in the present disclosure should be understood as open-ended terms that imply the possibility of including other embodiments, unless otherwise stated in the phrase or sentence in which the expression is included.

The singular forms described in the present disclosure may include plural meanings unless otherwise stated, and the same applies to the singular forms recited in the claims.

The expressions “first”, “second”, etc., used in the present disclosure are used to distinguish between multiple components, and do not limit the order or importance of the components.

In all components constituting a vehicle door checker assembly of the present disclosure, the direction toward the door is referred to as the “door side”, and the direction toward the vehicle body is referred to as the “body side”. For example, a door mounting part of the vehicle door checker assembly of the present disclosure may have a mounting flange mounted to the door, and the direction in which the mounting flange is installed may be the door side, and the opposite direction may be the body side.

In addition, in all components constituting the vehicle door checker assembly of the present disclosure, the direction facing the vehicle, which is perpendicular to the door side direction or the body side direction, is referred to as the “vehicle inner side”, and the opposite direction, that is, the direction away from the vehicle, is referred to as the “vehicle outer side”.

In the present disclosure, the vehicle door checker assembly changes the posture thereof as the door is opened. Therefore, it should be understood that the door side direction, body side direction, vehicle inner side direction, and vehicle outer side direction described above are not always constant directions, but change according to the change in the posture of the vehicle door checker assembly.

In addition, directional terms such as “upward”, “up”, etc. and directional terms such as “downward”, “down”, etc., used when describing the vehicle door checker assembly of the present disclosure are determined based on the extension direction of the pivot axis of a hinge through which the door is pivotally connected to the vehicle body. That is, one direction of the extension of the pivot axis is “upward”, “up”, and the opposite direction is “downward”, “down”.

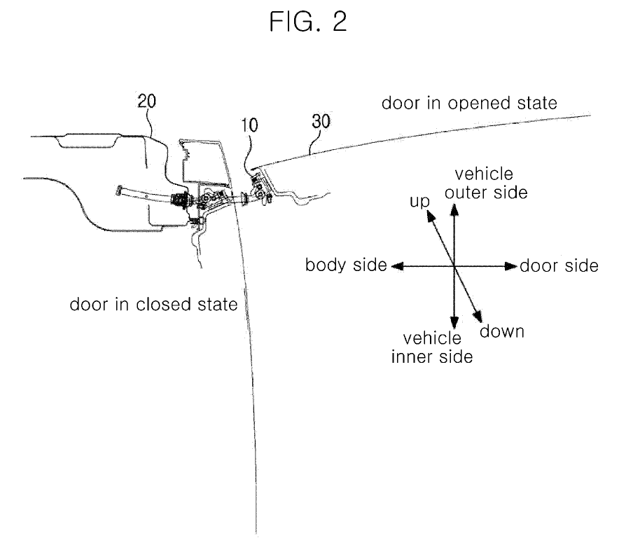

FIG. 2 is a view showing the opening and closing of a door of a vehicle having a vehicle door checker assembly installed according to an embodiment of the present disclosure.

As shown in FIG. 2, a vehicle door checker assembly 10 according to an embodiment of the present disclosure may be applied to a door 30 (e.g., a trunk door) installed at the rear of a vehicle. The door 30 may be installed as a double-door type as shown in FIG. 2.

The door 30 is pivotally connected to a vehicle body 20 by one or more hinges (not shown) installed separately from the door checker assembly. The door checker assembly 10 may be mounted, separately from the hinges, between the body 20 of the vehicle and the door 30 to perform the function of limiting the maximum opening angle of the door 30 and maintaining the door 30 open at a predetermined angle. FIG. 2 illustrates (for purposes of understanding) both a closed state of the door 30 and a state in which the door 30 is opened to a maximum opening angle (e.g., 95°) in one drawing.

However, especially in the case of a trunk door, a user may sometimes, for example, for the purpose of loading luggage, need to open the door 30 beyond the maximum opening angle and the vehicle door checker assembly 10 according to an embodiment of the present disclosure is configured to be able to open beyond a predetermined maximum opening angle when desired by the user.

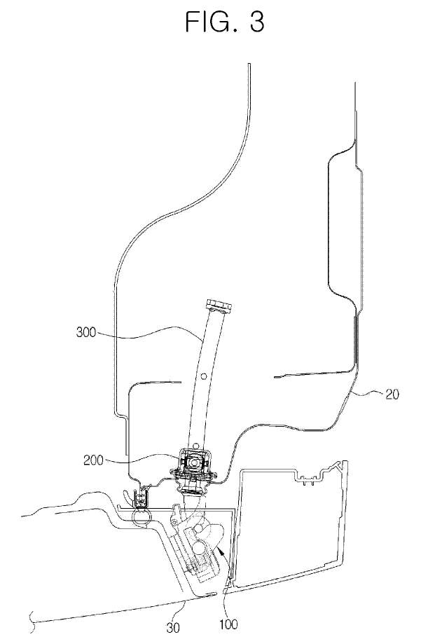

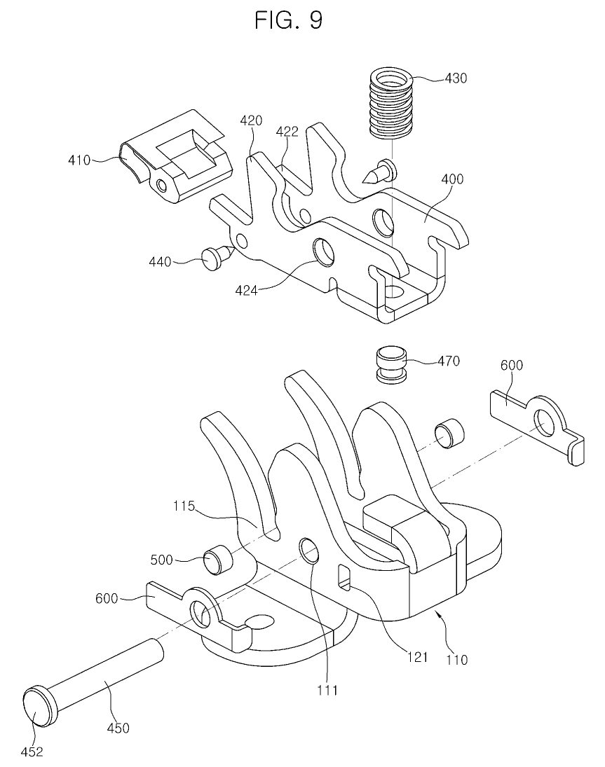

The vehicle door checker assembly 10 according to an embodiment of the present disclosure may include: a door mounting part 100 (e.g., as shown in FIG. 3) configured to be mounted on the door 30; a body mounting part 200 (e.g., as shown in FIG. 3) configured to be mounted on the body 20; a checker arm 300 (e.g., as shown in FIG. 3) that penetrates the body mounting part 200 and is movable relative to the body mounting part 200; and a locking latch 400 (e.g., as shown in FIG. 9) that moves the checker arm 300 between the latched position and the release position in cooperation with a coupling groove 115 (e.g., as shown in FIG. 9) of the door mounting part 100.

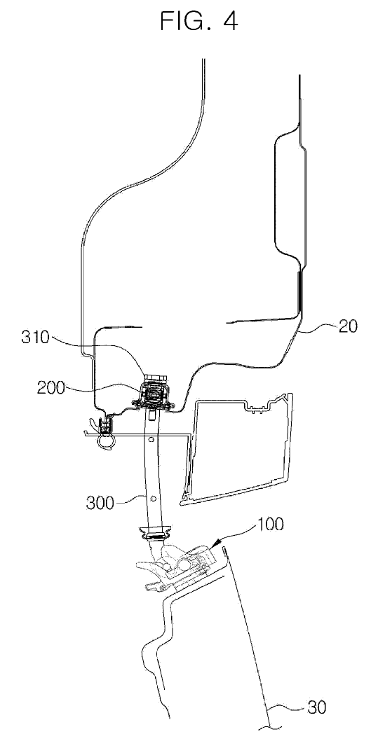

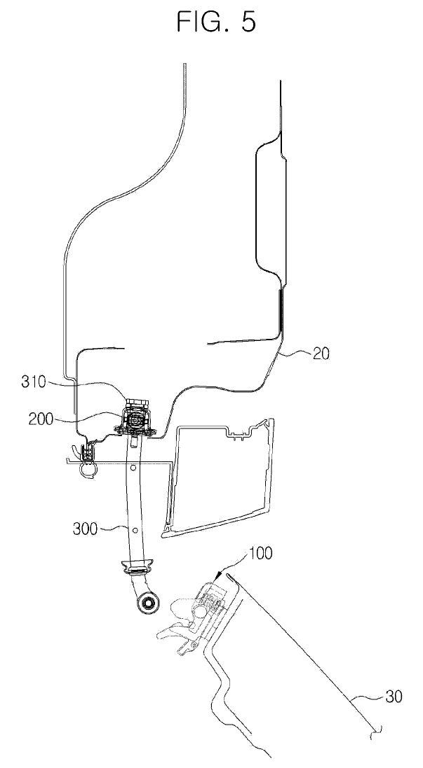

FIG. 3 shows a vehicle door checker assembly with the door closed according to an embodiment of the present disclosure. FIG. 4 shows a vehicle door checker assembly with the door opened to the maximum opening angle thereof according to an embodiment of the present disclosure. FIG. 5 shows a vehicle door checker assembly with the door opened beyond the maximum opening angle thereof according to an embodiment of the present disclosure.

As shown in FIGS. 3 and 4, in the vehicle door checker assembly 10, as the door 30 is opened from the closed state, the checker arm 300 penetrates the body mounting part 200 and slides relative to the body mounting part 200, and as a stopper 310 installed at the body-side end of the checker arm 300 touches the body mounting part 200, the door 30 opens to the maximum opening angle thereof and does not open any further.

In the process of opening the door 30 from the closed state of FIG. 3 to the opened state to the maximum opening angle of FIG. 4, the checker arm 300 is connected to the locking latch 400. The user may operate a lever so that the checker arm 300 is separated from the locking latch 400 while the door 30 is opened to the maximum opening angle as shown in FIG. 4, and as the checker arm 300 is separated from the locking latch 400, the door 30 may be further opened as shown in FIG. 5.

To facilitate understanding, the description assumes that the user operates the lever while the door 30 is opened to the maximum opening angle, but the user may also operate the lever before the door 30 reaches the maximum opening angle to make the checker arm 300 detachable from the locking latch 400. That is, as described below, the locking latch 400 according to an embodiment of the present disclosure is moved between the latched position and the release position through pivotal movement by lever operation, and such a movement is possible independently of the degree of the door opening angle. Thus, the user may make the checker arm 300 detachable from the locking latch 400 at any time by operating the lever.

In addition, although the locking latch 400 is separated from the checker arm 300 in FIG. 5, the door 30 is pivotally connected to the body 20 by one or more hinges (not shown), so that the door 30 is pivoted relative to the body 20 along a predetermined movement path determined by the hinges to open.

Hereinafter, the vehicle door checker assembly 10 according to an embodiment of the present disclosure will be described in more detail, assuming the door closing/opening mechanism described above.

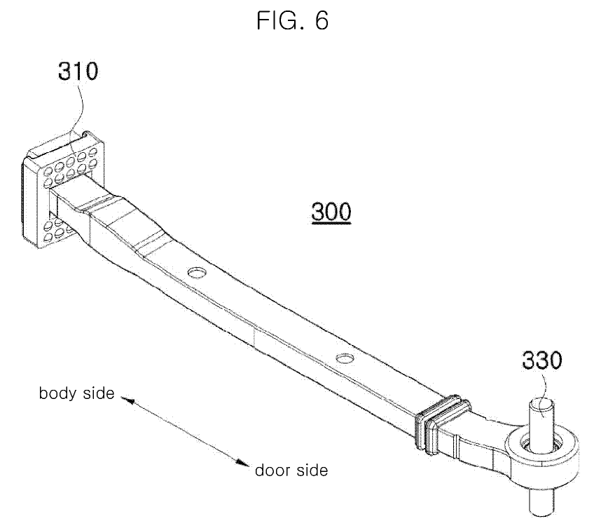

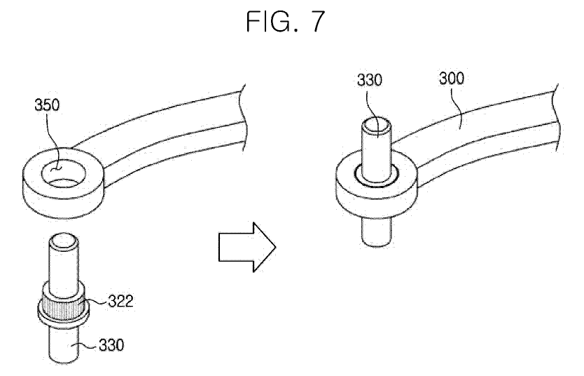

FIG. 6 shows a checker arm according to an embodiment of the present disclosure. FIG. 7 is a view showing the coupling of a checker arm and a pin according to an embodiment of the present disclosure.

As shown in FIG. 6, the checker arm 300 according to an embodiment of the present disclosure has the stopper 310 installed at the body-side end and a pin 330 installed at the door-side end.

In addition, as shown in FIG. 7, the pin 330 may be installed by being pressed into a through hole 350 formed at the door-side end of the checker arm 300. To ensure that the pin 330 is pressed more securely into the through hole 350 of the checker arm 300, a sawtooth-shaped serration 332 may be provided along the outer periphery of the portion of the pin 330 where the pin 330 is joined to the through hole 350.

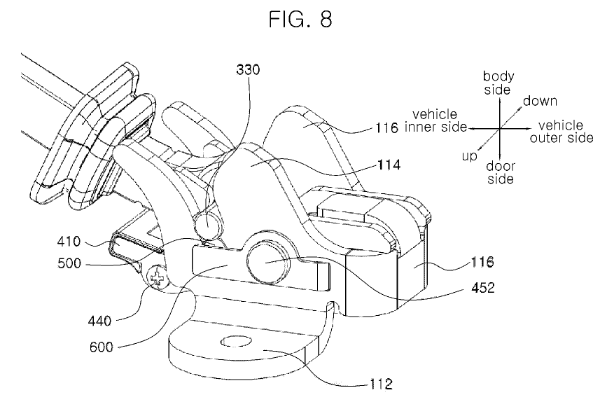

FIG. 8 is a partial perspective view of a vehicle door checker assembly according to an embodiment of the present disclosure. FIG. 9 is an exploded perspective view of a housing and components coupled therein of a vehicle door checker assembly according to an embodiment of the present disclosure.

As shown in FIGS. 8 and 9, the door mounting part 100 according to an embodiment of the present disclosure may consist of a housing 110 and parts accommodated inside the housing 110.

According to an embodiment of the present disclosure, the housing 110 has a mounting flange 112 for mounting to the door 30 and may have an opening for at least the checker arm 300 to be coupled and separated.

For example, the housing 110 may consist of: an upper plate 114; a lower plate 116 spaced apart from the upper plate 114 and facing the upper plate 114; and a connection plate 118 connecting the vehicle outer side end of the upper plate 114 and the vehicle outer side end of the lower plate 116. The door-side ends of the upper plate 114 and the lower plate 116 are each provided with the mounting flange 112.

Each of the upper plate 114 and the lower plate 116 may be configured to include a through hole 111 extending in the vehicle outer side or vehicle inner side direction. The through holes 111 may be configured to face each other.

A shaft 450 is provided that extends through the through holes 111 of the housing 110, and the shaft 450 is arranged to extend through through holes 424 formed in the locking latch 400 arranged within the housing 110. As an example, the shaft 450 may be in the form of a pin having a fixed flange. As an example, the shaft 450 may be installed to be fixed to the housing 110 by being inserted into the through holes so as to extend through the through holes and then having the opposite end thereof, that is, the other end, of the end provided with a fixing flange 452 riveted.

Due to this structure, the locking latch 400 may be pivotally positioned about the shaft 450 relative to the housing 110.

Each of the upper plate 114 and the lower plate 116 is provided with the coupling groove 115 formed to surround at least a portion of the outer surface of the pin 330 when the pin 330 of the checker arm 300 is coupled to the locking latch 400.

In the present disclosure, a damper member 500 is arranged in the coupling groove 115, and in the latched position, the pin 330 of the checker arm 300 is surrounded by the coupling groove 115, the locking latch 400, and the damper member 500.

According to an embodiment of the present disclosure, the locking latch 400 has a lever 410 installed at the vehicle inner side end thereof. The lever 410 may be fixed to the locking latch 400 by, for example, a coupling pin 440.

In addition, according to an embodiment of the present disclosure, the door mounting part 100 may have a biasing member 430 that biases the locking latch 400 in one direction so that the locking latch 400 is positioned in the latched position when the locking latch 400 is not subjected to an external force.

For example, the biasing member 430 may be, for example, a coil spring and may be installed inside the housing 110. One end of the coil spring may be positioned to contact the inner surface of the housing 110 and the other end of the coil spring may be positioned to contact the outer surface of the locking latch 400. A positioning member 470 to enable the coil spring to be in position may be coupled to the locking latch 400 so that at least a portion of the positioning member 470 may be positioned within the coil spring.

According to an embodiment of the present disclosure, the locking latch 400 may include a latch protrusion 420 configured to restrain the pin 330 of the checker arm 300 in cooperation with the coupling groove 115 of the housing 110 when the locking latch 400 is positioned in the latched position.

For example, the latch protrusion 420 may include a catching part 422, and the catching part 422 may be configured to restrain the pin 330 of the checker arm 300. As an example, the pin 330 of the checker arm 300 may move along a predetermined movement path as the door 30 is opened, and the catching part 422 may limit this movement path and restrain the pin 330 of the checker arm 300.

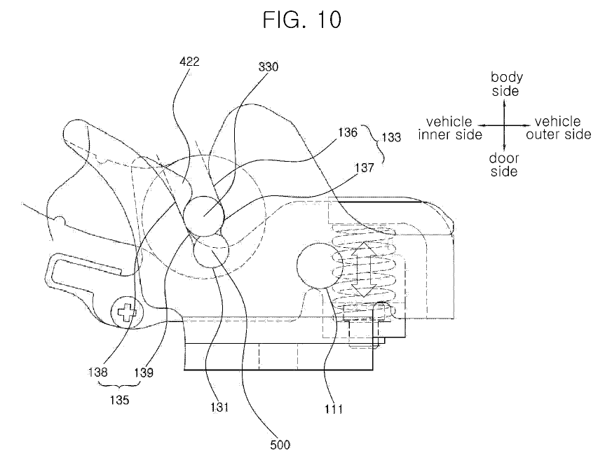

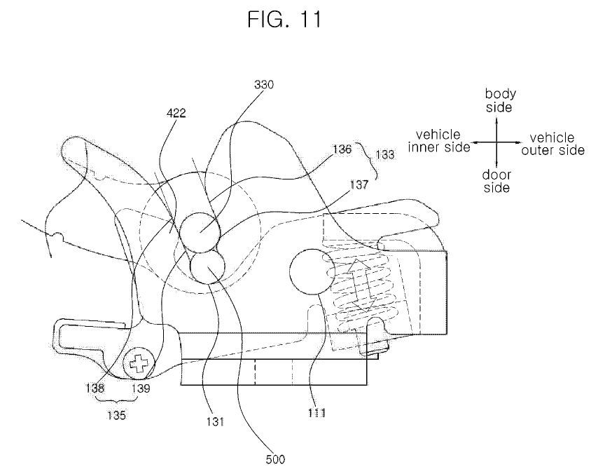

FIG. 10 shows a state in which a pin of a checker arm is coupled to a locking latch according to an embodiment of the present disclosure. FIG. 11 shows a state in which a pin of a checker arm is detached from a locking latch according to an embodiment of the present disclosure.

Hereinafter, the coupling and separation of the locking latch and the checker arm will be described in more detail with reference to FIGS. 10 and 11. In FIGS. 10 and 11, a cover 600 and the shaft 450 are omitted for convenience of illustration.

As shown in FIG. 10, when the pin 330 of the checker arm 300 is engaged by the locking latch 400, the pin 330 of the checker arm 300 is restrained by the catching part 422. That is, the locking latch 400 is a structure that can pivot about the shaft 450 with respect to the housing 110, and the locking latch 400 receives a biasing force that pivots the locking latch 400 clockwise by the biasing member 430, and therefore, the catching part 422 cooperates with the pin 330 of the checker arm 300 and the coupling groove 115 to keep the pin 330 in a latched state.

In addition, as shown in FIG. 11, when the user applies an external force to the locking latch 400 toward the door by operating the lever 410, the locking latch 400 pivots counterclockwise around the shaft 450, and accordingly, the catching part 422 does not restrain the pin 330 of the checker arm 300.

According to an embodiment of the present disclosure, the coupling groove 115 may include: a damper member coupling surface 131 to which the damper member 500 is coupled; a first inner surface 133 extending from one end of the damper member coupling surface 131; and a second inner surface 135 extending from the other end of the damper member coupling surface 131. In this specification, the damper member coupling surface 131 is defined as a surface of the inner surfaces of the coupling groove 115 into which the damper member 500 is fitted and joined.

According to an embodiment of the present disclosure, the cross-sectional shape formed by the damper member coupling surface 131 may be designed to partially correspond to the cross-sectional shape of the damper member 500. For example, the damper member 500 may be manufactured in a cylindrical shape so that the cross-sectional shape may be a circle, and the cross-sectional shape formed by the damper member coupling surface 131 may be partially a circle.

The damper member 500 may be an elastic member, and may be made of a rubber material as an example. As an example, the damper member 500 may be press-fitted into the damper member coupling surface 131.

According to an embodiment of the present disclosure, the first inner surface 133 may consist of: a first guide surface 136 configured to guide and move the pin 330 of the checker arm 300; and a first connection surface 137 connecting the first guide surface 136 and the damper member coupling surface 131. In this specification, the first guide surface 136 is defined as a surface of the inner surfaces of the coupling groove 115 along which the pin 330 of the checker arm 300 moves.

According to an embodiment of the present disclosure, preferably, the cross-sectional shape formed by the first connection surface 137 may be designed to partially correspond to the cross-sectional shape of the pin 330 of the checker arm 300. For example, the cross-sectional shape of the pin may be a circle, and the first connection surface 137 may be partially a circle.

According to an embodiment of the present disclosure, when the pin 330 of the checker arm 300 is in the latched position, the first connection surface 137 may be designed to be spaced apart from the pin 330 of the checker arm 300, or alternatively, the first connection surface 137 may be configured to contact the pin 330 of the checker arm 300.

Similar to the first inner surface 133, the second inner surface 135 may consist of: a second guide surface 138 configured to guide and move the pin 330 of the checker arm 300; and a second connection surface 139 connecting the second guide surface 138 and the damper member coupling surface 131. In this specification, the second guide surface 138 is defined as a surface of the inner surfaces of the coupling groove 115 along which the pin 330 of the checker arm 300 moves.

Although in the drawing, only the first connection surface 137 is illustrated as being designed to have a shape that partially corresponds to the cross-sectional shape of the pin 330, the structure of the first connection surface 137 and the second connection surface 139 of the present disclosure is not limited to this embodiment.

For example, the second connection surface 139 (not the first connection surface 137) may be designed to have a shape that partially corresponds to the cross-sectional shape of the pin 330, or alternatively, both the first connection surface 137 and the second connection surface 139 may be designed to have a shape that partially corresponds to the cross-sectional shape of the pin 330.

According to an embodiment of the present disclosure, the damper member 500 is arranged so that at least a portion thereof protrudes toward the vehicle body side more than the damper member coupling surface 131 of the coupling groove 115. Thus, the pin 330 of the checker arm 300 is guided and moved along the first guide surface 136 and the second guide surface 138 to come into contact with the portion of the damper member 500 that protrudes toward the vehicle body side, so that the impact when the pin 330 of the checker arm 300 is coupled to the coupling groove 115 is absorbed by the damper member 500, thereby reducing vibration and noise. In addition, since the pin 330 of the checker arm 300 is surrounded by the coupling groove 115, the damper member 500, and the latch protrusion 420 (more precisely, the catching part 422) of the locking latch 400 and is pivotally held in the latched position, there is no clearance that would inevitably occur (if there were no damper member due to manufacturing tolerances of the coupling groove, latch protrusion, etc.,), so that vibration or noise is reduced even when the pin 330 of the checker arm 300 rotates in the latched position.

According to an embodiment of the present disclosure, the cover 600 configured to cover the damper member 500 so that the damper member 500 does not come off outside the housing 110 may be additionally provided on the door mounting part. As an example, the cover 600 may be mounted to the door mounting part 100 by having at least a portion thereof interposed and fixed between the housing 110 and the fixing flange 452 of the shaft 450

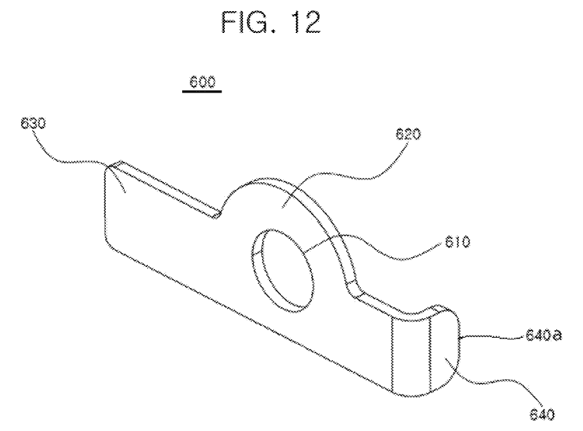

To be specific, FIG. 12 is a perspective view of a cover according to an embodiment of the present disclosure. According to an embodiment of the present disclosure, the cover 600 is manufactured as a single piece and may have an overall plate shape. The cover 600 includes: a shaft mounting part 620 having a through hole 610 through which the shaft 450 passes and having a shape at least partially corresponding to the fixing flange 452 of the shaft 450; and a damper member cover part 630 configured to cover the damper member 500.

According to the above-described structure, the damper member 500 is covered by the damper member cover part 630, so that the risk of the damper member 500 being detached from the housing 110 due to repeated impact is eliminated. In addition, since the shaft mounting part 620 of the cover 600 is interposed and fixed between the housing 110 and the fixing flange 452 of the shaft 450, the shaft mounting part 620 functions as a washer, so that the shaft 450 may be firmly coupled to the housing 110.

In addition, according to an embodiment of the present disclosure, as described above, in the case that the cover 600 is designed to not only cover the damper member 500 but also function as a washer, there may be a risk that the cover 600 will also rotate due to the rotation of the shaft 450. Considering this, according to an embodiment of the present disclosure, the cover 600 may be configured to further include a fitting joint part 640 that is coupled to the housing 110. In this case, the fitting joint part 640 includes a protrusion 640a protruding toward the housing 110, and a hole 121 or a concave groove that is coupled with the protrusion 640a may be formed in the housing 110.

In addition, in order to better suit the purpose of preventing rotation described above, the cover 600 may be configured such that the damper member cover part 630 is disposed at one end of the cover 600 and the fitting joint part 640 is disposed at the other end of the cover 600, and the shaft mounting part 620 is disposed between the damper member cover part 630 and the fitting joint part 640.

Although the preferred embodiment of the present disclosure has been described above, the present disclosure is not limited to the above embodiment, and includes all changes that can be easily modified and deemed equivalent by a person having ordinary knowledge in the technical field to which the present disclosure pertains from the embodiment of the present disclosure.

What is claimed is:

1. A vehicle door checker assembly mounted between a vehicle body and a door to assist in an opening and closing operation of the door, the vehicle door checker assembly comprising:
a body mounting part configured to be mounted on the vehicle body;
a door mounting part configured to be mounted on the door;
a checker arm configured to penetrate the body mounting part and move relative to the body mounting part; and
a locking latch configured to move the checker arm between a latched position and a release position in cooperation with a coupling groove of the door mounting part,
wherein:
a damper member is arranged in the coupling groove of the door mounting part, and
in the latched position, a portion of the checker arm is surrounded by the coupling groove, the locking latch and the damper member.

2. The vehicle door checker assembly of claim 1, wherein:
the coupling groove comprises:
a damper member coupling surface on which the damper member is installed;
a first inner surface extending from a first end of the damper member coupling surface; and
a second inner surface extending from a second end of the damper member coupling surface, and
the portion of the checker arm is guided toward the damper member along at least one of the first inner surface and the second inner surface so as to come into contact with the damper member.

3. The vehicle door checker assembly of claim 2, wherein a cross-sectional shape formed by the damper member coupling surface partially corresponds to a cross-sectional shape of the damper member.

4. The vehicle door checker assembly of claim 2, wherein:
the first inner surface comprises:
a first guide surface configured to guide and move the portion of the checker arm; and
a first connection surface connecting the first guide surface and the damper member coupling surface, and
a cross-sectional shape formed by the first connection surface partially corresponds to a cross-sectional shape of the portion of the checker arm.

5. The vehicle door checker assembly of claim 4, wherein the first connection surface is configured to come into contact with the portion of the checker arm.

6. The vehicle door checker assembly of claim 1, wherein the door mounting part comprises:
a housing in which the coupling groove is formed; and
a cover configured to at least partially cover the damper member so that the damper member does not come out of the housing.

7. The vehicle door checker assembly of claim 6, wherein:
the door mounting part further comprises a shaft for pivotally mounting the locking latch to the housing, and
a portion of the cover is interposed and fixed between the housing and a fixing flange of the shaft.

8. The vehicle door checker assembly of claim 7, wherein the cover comprises:
a shaft mounting part provided with a through hole through which the shaft passes and having a shape at least partially corresponding to the fixing flange of the shaft; and
a damper member cover part configured to at least partially cover the damper member.

9. The vehicle door checker assembly of claim 8, wherein the cover further comprises:
a fitting joint part that is coupled to the housing.

10. The vehicle door checker assembly of claim 9, wherein the shaft mounting part is arranged between the damper member cover part and the fitting joint part.

11. The vehicle door checker assembly of claim 9, wherein the fitting joint part comprises a protrusion protruding toward the housing, and
a hole or a concave groove that is coupled with the protrusion is formed in the housing.

12. The vehicle door checker assembly of claim 1, wherein the damper member is made of rubber material.

13. The vehicle door checker assembly of claim 1, wherein the checker arm comprises a pin at a door-side end thereof, and the pin operates as the portion of the checker arm.

14. A vehicle door checker assembly, comprising:
a body mounting part configured to be mounted on a vehicle body;
a door mounting part configured to be mounted on a vehicle door;
a checker arm configured to penetrate the body mounting part and move relative to the body mounting part; and
a locking latch configured to move the checker arm between a latched position and a release position in cooperation with a coupling groove of the door mounting part; and
a damper member arranged in the coupling groove of the door mounting part,
wherein in the latched position, a portion of the checker arm is surrounded by the coupling groove, the locking latch and the damper member.

15. The vehicle door checker assembly of claim 14, wherein:
the coupling groove comprises:
a damper member coupling surface on which the damper member is installed;
a first inner surface extending from a first end of the damper member coupling surface; and
a second inner surface extending from a second end of the damper member coupling surface, and
the portion of the checker arm is guided toward the damper member along at least one of the first inner surface and the second inner surface so as to come into contact with the damper member.

16. The vehicle door checker assembly of claim 15, wherein a cross-sectional shape formed by the damper member coupling surface partially corresponds to a cross-sectional shape of the damper member.

17. The vehicle door checker assembly of claim 16, wherein:
the first inner surface comprises:
a first guide surface configured to guide and move the portion of the checker arm; and
a first connection surface connecting the first guide surface and the damper member coupling surface, and
a cross-sectional shape formed by the first connection surface partially corresponds to a cross-sectional shape of the portion of the checker arm.

18. A vehicle door checker assembly, comprising:
a body mounting part configured to be mounted on a vehicle body;
a door mounting part configured to be mounted on a vehicle door, wherein the door mounting part comprises:
a housing in which a coupling groove is formed; and
a cover configured to at least partially cover a damper member so that the damper member does not come out of the housing;
a checker arm configured to penetrate the body mounting part and move relative to the body mounting part; and
a locking latch configured to move the checker arm between a latched position and a release position in cooperation with the coupling groove of the door mounting part; and
the damper member arranged in the coupling groove of the door mounting part,
wherein in the latched position, a portion of the checker arm is surrounded by the coupling groove, the locking latch and the damper member.

19. The vehicle door checker assembly of claim 18, wherein:
the door mounting part further comprises a shaft for pivotally mounting the locking latch to the housing, and
a portion of the cover is interposed and fixed between the housing and a fixing flange of the shaft.

20. The vehicle door checker assembly of claim 19, wherein the cover comprises:
a shaft mounting part provided with a through hole through which the shaft passes and having a shape at least partially corresponding to the fixing flange of the shaft; and
a damper member cover part configured to at least partially cover the damper member.
